(19) United States
(12) Patent Application Publication
(10) Pub. No.: US 2011/0115287 A1
(43) Pub. Date: May 19, 2011

(54) VEHICULAR POWER SUPPLY CIRCUIT

(75) Inventors: Manabu Morita, Anjo-city (JP); Koichi Sato, Anjo-city (JP); Motoharu Oda, Okazaki-city (JP); Nobutomo Takagi, Okazaki-city (JP); Hideo Suganuma, Okazaki-city (JP); Jiro Ito, Toyota-city (JP)

(73) Assignees: ANDEN CO., LTD., Anjo-city (JP); TOYOTA JIDOSHA KABUSHIKI KAISHA, Toyota-city (JP)

(21) Appl. No.: 12/944,866

(22) Filed: Nov. 12, 2010

(30) Foreign Application Priority Data
Nov. 19, 2009 (JP) 2009-263850

(51) Int. Cl. H02G 3/00

(52) U.S. Cl. 307/9.1

(57) ABSTRACT

A vehicular power supply circuit for supplying power to loads from a battery to drive the loads includes a power line and noise protection circuits. The power line is connected to the loads and systematically separated into multiple power lines based on characteristics of the loads to be connected. Each noise protection circuit is provided to a corresponding power line on the upstream side of the loads connected to the corresponding power line to serve as a common noise protection circuit for the loads connected to the corresponding power line.

### CROSS REFERENCE TO RELATED APPLICATION

This application is based on and incorporates herein by reference Japanese Patent Application No. 2009-263850 filed on Nov. 19, 2009.

### FIELD OF THE INVENTION

The present invention relates to a vehicular power supply circuit for supplying electrical power to electrical loads of a vehicle.

### BACKGROUND OF THE INVENTION

As disclosed in, for example, JP 6-32186 A, a conventional power supply circuit for a vehicle has two main power supply systems, one of which is a battery system, and the other of which is an ignition (IG) system. The battery system is connected directly to a battery so that power can be supplied to the battery system regardless of whether an IG switch of a vehicle is ON or OFF. On the other hand, the IG system is supplied with power only when the IG switch is ON. For example, a headlamp and an electronic control unit (ECU) for controlling a keyless entry apparatus that performs door lock control are connected to a power line of the battery system. On the other hand, an audio apparatus and an ECU for controlling an air conditioner are connected to a power line of the IG system.

In the conventional power supply circuit, power loads and other loads such as CPU-based ECUs are connected to the battery system and the IG system in a mixed manner without being systematically grouped. Therefore, it is difficult to integrate noise protection circuits for the loads into a common noise protection circuit on the upstream side of the power supply circuit. As a result, each load needs to have an individual noise protection circuit, and the power supply circuit as a whole is increased in cost.

FIG. 4 illustrates a circuit diagram of such a conventional vehicular power supply circuit. As shown in FIG. 4, a power line 102 of a battery system is connected to a battery 101, and a power line 104 of an IG system is connected to the battery 101 through a relay 103 that is turned ON when an IG switch is turned ON. The power line 104 of the IG system is connected to a power line 106 of an alternator (ALT) system on the upstream side (i.e., battery 101-side) of the relay 103. The power line 106 is connected to an ALT 105 that charges the battery 101. It can be considered that the ALT system is basically included in the battery system.

As can be seen from FIG. 4, ECUs 107-109 and power loads 110-112 are connected to the power lines 102, 106 of the battery system and the power line 104 of the IG system without being systematically grouped. Therefore, each of the ECUs 107-109 and the power loads 110-112 has an individual noise protection circuit. Specifically, the noise protection circuits of the ECUs 107-109 are constructed with zener diodes 107a-109a, capacitors 107b-109b, and diodes 107c-109c, respectively. The zener diodes 107a-109a and the capacitors 107b-109b prevent a high voltage from being applied to internal circuitry, when a surge occurs. The diodes 107c-109c prevent short-circuit current flow under a reverse connection condition where negative and positive terminals of the battery 101 are reversely connected. The noise protection circuits of the power loads 110-112 are constructed with diodes 110a-112a, respectively. The diodes 110a-112a prevent short-circuit current flow under the reverse connection condition.

As described above, in the conventional power supply circuit, the ECUs 107-109 and the power loads 110-112 are connected to the battery system and the IG system in a mixed manner. Therefore, there is a need to provide an individual noise protection circuit to each of the ECUs 107-109 and the power loads 110-112. As a result, the conventional power supply circuit as a whole is increased in cost. In particular, since short-circuit current flowing through the power loads 110-112 under the reverse connection condition is large, the diodes 110a-112a provided to the power loads 110-112 need to be large in size. Addition of such a large diode to each of the power loads 110-112 can result in a large increase in cost.

### SUMMARY OF THE INVENTION

In view of the above, it is an object to provide a vehicular power supply circuit having a common noise protection circuit on its upstream side.

According to an aspect of the present invention, a vehicular power supply circuit for supplying power to loads from a battery to drive the loads includes a power line connected to the loads. The power line is systematically separated into multiple power lines based on characteristics of the loads to be connected. The vehicular power supply circuit further includes multiple noise protection circuits. Each noise protection circuit is provided to a corresponding power line on the upstream side of the loads connected to the corresponding power line so as to serve as a common noise protection circuit for the loads connected to the corresponding power line.

### BRIEF DESCRIPTION OF THE DRAWINGS

The above and other objectives, features and advantages of the present invention will become more apparent from the following detailed description made with check to the accompanying drawings. In the drawings:

FIG. 1 is a circuit diagram of a vehicular power supply circuit according to an embodiment of the present invention;

FIG. 2 is a brief diagram illustrating loads connected to systematically-separated power lines of the vehicular power supply circuit;

FIGS. 3A-3E are diagrams illustrating noise protection circuits according to modifications of the embodiment; and

FIG. 4 is a circuit diagram of a conventional vehicular power supply circuit.

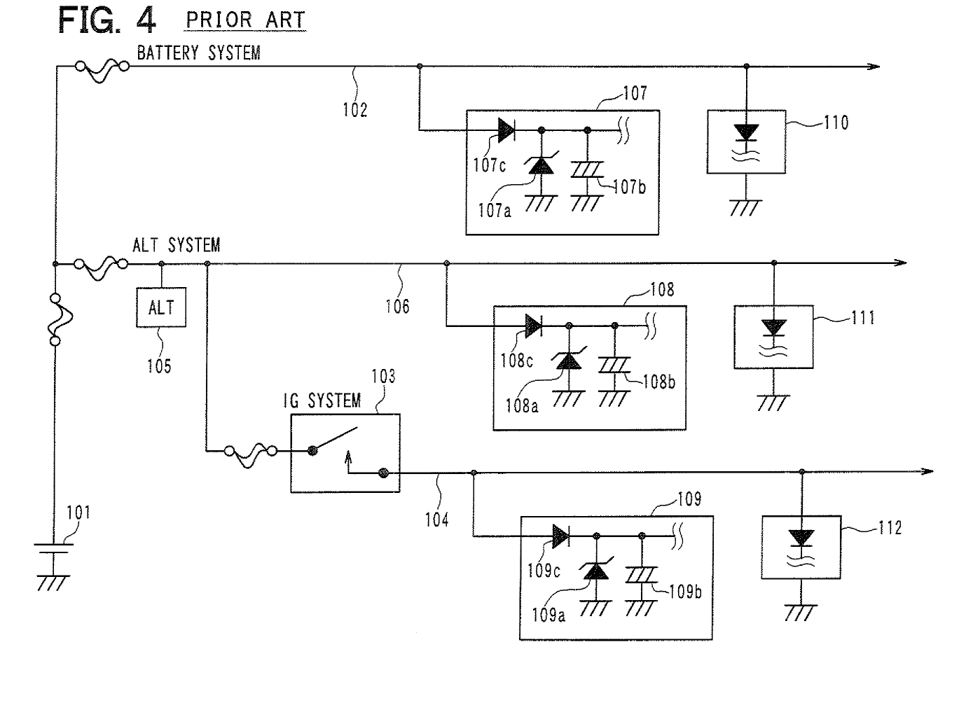

### DETAILED DESCRIPTION OF THE PREFERRED EMBODIMENT

### Embodiment

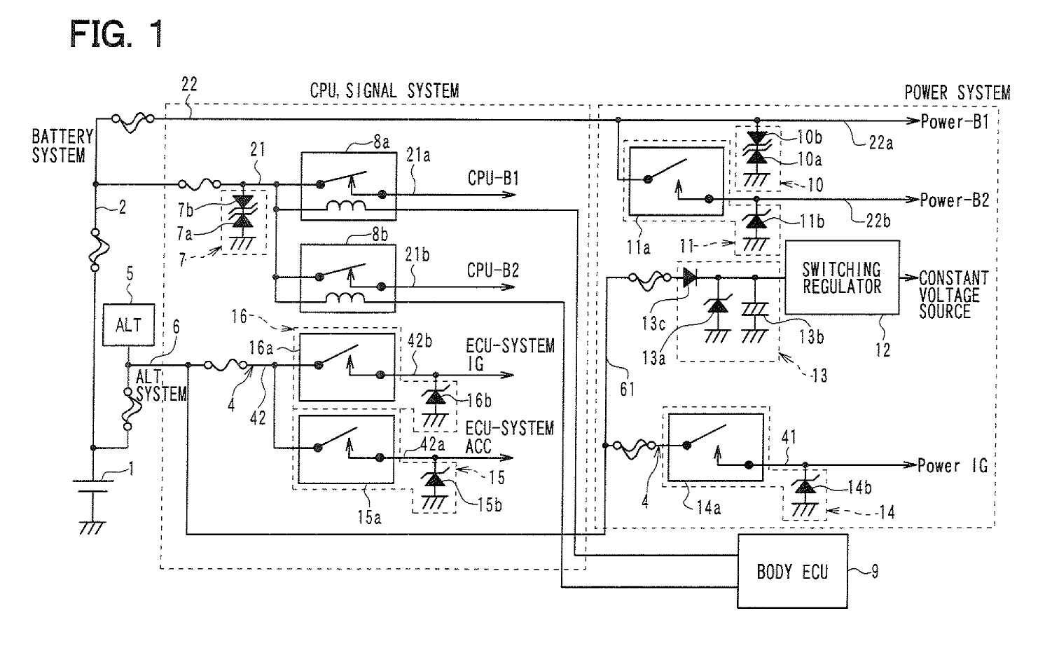

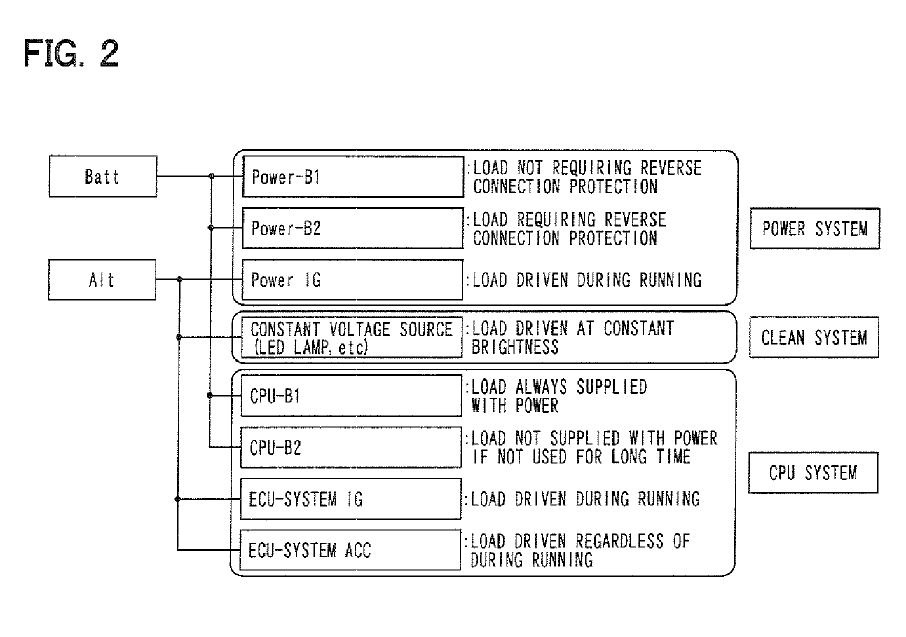

An embodiment of the present invention is described below with reference to FIGS. 1 and 2. FIG. 1 illustrates a circuit diagram of a vehicular power supply circuit according to the embodiment of the present invention. FIG. 2 is a brief diagram illustrating loads connected to systematically-separated power lines of the vehicular power supply circuit.

In the vehicular power supply circuit shown in FIG. 1, a main power line connected to a battery 1 is systematically separated into sub-power lines based on characteristics of loads, such as ECUs and power loads, to be connected. FIG. 2 conceptually shows how to separate the main power line into the sub-power lines.

Specifically, as shown in FIG. 1, the main power line is separated into a power line 2 (as a first power line) and a power line 4 (as a second power line). The power line 2 serves as a power line of a battery system that is connected directly to the battery 1, and the power line 4 serves as a power line of an ignition (IG) system that is connected to the battery 1 through relays 14a-16a that are turned ON when an ignition (IG) switch of a vehicle is turned ON. The power line 4 of the IG system is connected to a power line 6 of an alternator (ALT) system on the upstream side (i.e., battery 1-side) of the relays 14a-16a. The power line 6 is connected to an ALT 105 that charges the battery 1. It can be considered that the ALT system can be included in the battery system.

The power line 2 of the battery system is further separated into a line 21 (as a small current line) and a line 22 (as a large current line). The line 22 serves as a power line of a power system for supplying power to power loads that use relatively large current. The line 21 serves as a power line of a CPU system for supplying power to small loads, such as ECUs, that use relatively small current to control the power loads. Each system has a different noise protection circuit.

For example, the line 21 of the CPU system is connected to ECUs (not shown) for controlling a keyless entry apparatus and a power seat apparatus. An apparatus, such as a keyless entry apparatus, for door lock control needs to be supplied with power even during a period of time when a user is outside the vehicle. Likewise, an apparatus for power seat control needs to be supplied with power to adjust seat position before a user enters the vehicle and an engine runs. Therefore, the ECUs for controlling the keyless entry apparatus and the power seat apparatus are connected to the CPU system, i.e., the battery system.

The line 21 of the CPU system is provided with a noise protection circuit 7 including Zener diodes 7a and 7b. The Zener diode 7a serves as a positive surge protection device for preventing a high voltage from being applied to the loads connected to the line 21, when a positive surge occurs. The Zener diode 7b serves as a negative surge protection device for preventing a low voltage from being applied to the loads connected to the line 21, when a negative surge occurs. Further, the Zener diode 7b serves as a reverse connection protection device for preventing a short-circuit current from flowing to the loads connected to the line 21 under a reverse connection condition where negative and positive terminals of the battery 1 are reversely connected.

Specifically, when a positive surge occurs, a large positive voltage may be applied to the loads connected to the line 21. The Zener diode 7a limits the large positive voltage to a value (i.e., Zener breakdown voltage) that depends on characteristics of the Zener diode 7a. Therefore, a voltage greater than the Zener breakdown voltage of the Zener diode 7a is not applied to the loads connected to the line 21 on the downstream side of the Zener diode 7a. Likewise, when a negative surge occurs, a large negative voltage may be applied to the loads connected to the line 21. The Zener diode 7b limits the large negative voltage to a value (i.e., Zener breakdown voltage) that depends on characteristics of the Zener diode 7b. Therefore, a voltage less than the Zener breakdown voltage of the Zener diode 7b is not applied to the loads connected to the line 21 on the downstream side of the Zener diode 7b.

Further, when the reverse connection condition occurs, the Zener diode 7b prevents a short-circuit current from flowing to the battery 1-side through the line 21. The two Zener diodes 7a, 7b of the noise protection circuit 7 are connected in opposite directions to interrupt currents in both directions. Thus, the noise protection circuit 7 can protect the loads connected to the line 21 from both noise due to the surge and noise due to the short-circuit current.

The line 21 of the CPU system is further separated into a line 21a and a line 21b. The line 21a serves as a power line of a CPU-B1 system to which loads that basically need to be always supplied with power from the battery 1 are connected. For example, an ECU for the keyless entry apparatus is connected to the line 21a. The line 21b serves as a power line of a CPU-B2 system to which loads that preferably be always supplied with power from the battery 1 are connected. It is noted that power supply to the loads connected to the line 21b can be interrupted if the loads are not used by a user for a long period of time. For example, an ECU for the power seat apparatus is connected to the line 21b.

The lines 21a, 21b are provided with latch relays 8a, 8b, respectively. Like a seesaw switch, each of the latch relays 8a, 8b stays ON or OFF by itself once it is switched ON or OFF by a single-shot control signal. For example, the latch relays 8a, 8b can be controlled by a body ECU 9. In this case, when the body ECU 9 supplies a driving current as the control signal to coils of the latch relays 8a, 8b, the latch relays 8a, 8b are turned OFF from ON so that the lines 21a, 21b can be disconnected from the battery 1. When the vehicle has been not used for a long period of time or when it is sure that the vehicle is not used for a long period of time, power supply to the lines 21a, 21b can be interrupted by the latch relays 8a, 8b to prevent a so-called dark current.

For example, when the body ECU 9 detects that the vehicle has been not used for a long period of time, the body ECU 9 supplies the driving current to the latch relay 8b so as to interrupt power supply to the line 21b. For another example, when the vehicle is transported over a long period of time by ship or the like, the body ECU 9 is controlled through an external apparatus before transportation of the vehicle so that the body ECU 9 can supply the driving current to the latch relay 8a so as to interrupt power supply to the line 21a. In this way, power supply to the loads connected to the line 21 of the battery system, which is directly connected to the battery 1, can be interrupted by the latch relays 8a, 8b. Thus, the dark current is prevented so that wasted power consumption in the line 21 can be reduced.

Conventionally, when a vehicle is transported by ship or the like, a fuse of each system is removed in order to reduce wasted power consumption. However, such a conventional method requires a lot of time and effort. In contrast, according to the first embodiment, power supply can be easily, automatically interrupted by using the external apparatus.

Power loads (not shown) such as a headlamp and a radiator fan motor are connected to a line 22 of the power system. The line 22 of the power system is further separated into a line 22a and a line 22b. The line 22a serves as a power line of a Power-B1 system for driving power loads that do not require protection against the reverse connection condition. The line 22b serves as a power line of a Power-B2 system for driving power loads that require protection against the reverse connection condition.

The line 22a that does not require protection against the reverse connection condition is provided with a noise protection circuit 10 including Zener diodes 10a and 10b. The Zener diode 10a prevents a high voltage from applying to the power loads connected to the line 22a, when a surge occurs. The Zener diode 10b prevents a short-circuit current from flowing to the power loads connected to the line 22a, when the reverse connection condition occurs. The noise protection circuit 10 can function in the same way as the noise protection circuit 7. Therefore, the noise protection circuit 10 can protect the power loads connected to the line 22a from both noise due to the surge and noise due to the short-circuit current. In this way, since noise protection circuits for the power loads connected to the line 22a are integrated into a common noise protection circuit 10, there is no need that each of the power loads connected to the line 22a has an individual noise protection circuit.

The noise protection circuit 10 has only the Zener diode 10b as a reverse connection protection device for preventing the short-circuit current under the reverse connection condition. Therefore, it is not always sure that the short-circuit current does not flow to the power loads connected to the line 22a on the downstream side of the noise protection circuit 10. However, the line 22a is connected to the power loads, such as a headlamp, that do not require protection against the reverse connection condition. For example, even when the short-circuit current flows to the headlamp, the headlamp illuminates only so that the short-circuit current can be consumed. Therefore, the short-circuit current flowing to the power loads connected to the line 22a causes no problems.

The line 22b that requires protection against the reverse connection condition is provided with a noise protection circuit 11 including a relay 11a and a Zener diode 11b. The Zener diode 11b prevents a high voltage from being applied to the power loads connected to the line 22b, when a surge occurs.

For example, the relay 11a can be controlled by an ECU such as the body ECU 9. The relay 11a is turned OFF from ON to disconnect the line 22b from the battery 1, when all the power loads connected to the line 22b on the downstream side of the relay 11a become inoperative or when a user is outside the vehicle. For example, the ECU such as the body ECU 9 determines whether all the power loads connected to the line 22b on the downstream side of the relay 11a are inoperative based on drive request signals from the power loads or determines whether a user is outside the vehicle based on a detection signal from a camera that monitors the inside of the vehicle. Then, the ECU such as the body ECU 9 turn ON or OFF the relay 11a based on the determination result.

As described above, the noise protection circuit 11 provided to the line 22b has both the relay 11a and the Zener diode 11b. When the reverse connection occurs, the relay 11a is turned OFF to prevent the short-circuit current from flowing to the line 22b. When a surge occurs, the Zener diode 11b prevents the high voltage from being applied to the power loads connected to the line 22b.

Since the relay 11a can surely serve as protection against the reverse connection condition, the noise protection circuit 11 needs only the Zener diode 11b to interrupt current flow in one direction. In other words, the noise protection circuit 11 does not need two Zener diodes to interrupt current flow in both directions. In this way, the noise protection circuit 11 can protect the power loads connected to the line 22b from both noise due to the surge and noise due to the short-circuit current. Since noise protection circuits for the power loads connected to the line 22b are integrated into a common noise protection circuit 11, there is no need that each of the power loads connected to the line 22b has an individual noise protection circuit.

For example, a radiator fan motor is connected to the line 22a that requires protection against the reverse connection condition. Assuming that the radiator fan motor is configured to be driven by a metal-oxide-semiconductor (MOS) switch having a freewheel diode, the short-circuit current may flow to the freewheel diode or a parasitic diode of the MOS switch under the reverse connection condition. Since the noise protection circuit 11 has the relay 11a, the relay 11a can surely prevent the short-circuit current from flowing to the freewheel diode or the parasitic diode under the reverse connection condition.

The power line 6 of the ALT system is defined as a line 61 serving as a power line of a clean system for generating a constant voltage based on a voltage of the battery 1.

The line 61 is provided with a switching regulator 12 that generates a constant voltage based on a voltage of the battery 1. Power loads that are driven by the constant voltage are connected to the line 61 on the downstream side of the switching regulator 12. For example, a light-emitting diode (LED) lamp for illuminating a meter can be connected to the line 61 on the downstream side of the switching regulator 12. In such an approach, the LED lamp is driven by the constant voltage so that the intensity of light emitted by the LED lamp can be kept constant.

A noise protection circuit 13 is provided to the line 61 on the upstream side of the switching regulator 12. The noise protection circuit 13 includes a Zener diode 13a, a capacitor 13b, and a diode 13c. The Zener diode 13a and the capacitor 13b prevent a high voltage from being applied to the power loads connected to the line 61, when a surge occurs.

The diode 13c prevents a short-circuit current from flowing to the power loads connected to the line 61, when the reverse connection condition occurs. Since noise protection circuits for the power loads connected to the line 61 are integrated into a common noise protection circuit 13 that is connected to the line 61 on the upstream side of the switching regulator 12, there is no need that each of the power loads connected to the line 61 has an individual noise protection circuit.

The power line 4 of the IG system is connected to the power line 6 of the ALT system on the upstream side of the noise protection circuit 13. The power line 4 of the IG system has a line 41 and a line 42. The line 41 serves as a power line of a Power-IG system for supplying power to power loads that need relatively large power. The line 42 serves as a power line of a CPU system for supplying power to loads such as ECUs for controlling the power loads connected to the line 41. Each of the line 41 and the line 42 has a different noise protection circuit.

The line 41 is provided with a noise protection circuit 14 including a relay 14a and a Zener diode 14b. The relay 14a is turned ON, when the IG switch is turned ON. The Zener diode 14b prevents a high voltage from being applied to the power loads connected to the line 41, when a surge occurs. For example, power loads such as a wiper motor are connected to the line 41 on the downstream side of the relay 14a, and the Zener diode 14b is connected to the line 41 on the downstream side of the relay 14a and on the upstream side of the power loads.

When the reverse connection condition occurs, the IG switch is OFF so that the relay 14a can be kept OFF to prevent the short-circuit current from flowing to the line 41. When a surge occurs, the Zener diode 14b prevents a high voltage from being applied to the power loads connected to the line 41. Since the relay 14a can surely serve as protection against the reverse connection condition, the noise protection circuit 14 needs only one Zener diode 14b to interrupt current flow in one direction. In other words, the noise protection circuit 14 does not need two Zener diodes to interrupt current flow in both directions.

In this way, the noise protection circuit 14 can protect the power loads connected to the line 41 from both noise due to the surge and noise due to the short-circuit current. Since noise protection circuits for the power loads connected to the line 41 are integrated into a common noise protection circuit 14, there is no need that each of the power loads connected to the line 41 has an individual noise protection circuit.

The line 42 is further separated into a line 42a and a line 42b. The line 42a serves as a power line of an ECU-system ACC for supplying power when an accessory (ACC) switch of the vehicle is turned ON. The line 42b serves as a power line of an ECU-system IG for supplying power when the IG switch is turned ON.

The line 42a is provided with a noise protection circuit 15 including a relay 15a and a Zener diode 15b. The relay 15a is turned ON, when the ACC switch is turned ON. The Zener diode 15b prevents a high voltage from being applied to loads connected to the line 42a, when a surge occurs. Signal load, such as an audio apparatus, that uses small current are connected to the line 42a on the downstream side of the relay 15a. When the ACC switch is turned ON, the relay 15a is turned ON to supply power to the signal loads connected to the line 42a.

The line 42b is provided with a noise protection circuit 16 including a relay 16a and a Zener diode 16b. The relay 16a is turned ON, when the IG switch is turned ON. The Zener diode 16b prevents a high voltage from being applied to loads connected to the line 42b, when a surge occurs. Signal loads, such as an air conditioner ECU, are connected to the line 42b on the downstream side of the relay 16a. When the IG switch is turned ON, the relay 16a is turned ON to supply power to the signal loads connected to the line 42b.

As described above, when the reverse connection condition occurs, the IG switch and the ACC switch are OFF so that the relays 15a, 16a can be kept OFF to prevent the short-circuit current from flowing to the lines 42a, 42b, respectively. When a surge occurs, the Zener diodes 15b, 16b prevent high voltages from being applied to the loads connected to the lines 42a, 42b, respectively. Since the relays 15a, 16a can surely serve as protection against the reverse connection condition, each of the noise protection circuits 15, 16 needs only one Zener diodes 15b, 16b to interrupt current flow in one direction. In other words, each of the noise protection circuits 15, 16 does not need two Zener diodes to interrupt current flow in both directions.

In this way, the noise protection circuits 15, 16 can protect the loads connected to the lines 42a, 42b from both noise due to the surge and noise due to the short-circuit current. Since noise protection circuits for the loads connected to the lines 42a, 42b are integrated into common noise protection circuits 15, 16, respectively, there is no need that each of the loads connected to the lines 42a, 42b has an individual noise protection circuit.

In summary, according to the embodiment, as shown in FIG. 2, the power line is separated into the battery system, which is connected directly to the battery 1, and the IG system. The battery system and the IG system are further separated based on characteristics of the loads, such as the power loads and the ECUs, to be connected. That is, the battery system and the IG system are further separated into the power system, which uses a large current, and the CPU system, which uses a small current such as signal. If the clean system that always needs a constant voltage is required, the power line can be separated into the battery system, the IG system, and the clean system. Further, the power system of the battery system is separated into the Power-B1 system, to which the power loads requiring protection against the reverse connection condition are connected, and the Power-B2 system, to which the power loads requiring no protection against the reverse connection condition are connected. The power system of the IG system is defined as a Power-IG system to which power loads that are driven during running of the vehicle are connected. Furthermore, the CPU system of the battery system is separated into the CPU-B1 system, to which loads that basically need to be always supplied with power are connected, and the CPU-B2 system, to which the loads that preferably be always supplied with power. It is noted that power supply to the loads connected to the CPU-B2 system can be interrupted if the loads are not used for a long period of time. Furthermore, the CPU system of the IG system is separated into the ECU-system IG, to which loads that are driven during running of the vehicle are connected, and the ECU-system ACC, to which loads that are driven regardless of during running of the vehicle are connected.

In this way, the power line is systematically separated based on characteristics of the loads to be connected, and a noise protection circuit suitable for each separated line is provided to protect the loads from noise. In such an approach, noise protection circuits for the loads connected to each separated line are integrated into a common noise protection circuit that is located on the most upstream side of each separated line. Therefore, there is no need that each of the loads and the ECUs connected to the downstream side of the common noise protection circuit has an individual noise protection circuit. Accordingly, the loads and the ECUs can be simplified so that the overall cost can be reduced.

(Modification)

The embodiment described above can be modified in various ways, for example, as follows.

In the embodiment, the power line is separated into the battery system and the IG system, and a part of the battery system is defined as the ALT system. The power line can be separated in a manner different from the manner described in the embodiment. For example, in the case of a hybrid vehicle or an electric vehicle, the power line can be separated into a battery system directly connected to a battery, and a system to which power is supplied when an activation switch such as a push start switch corresponding to an ACC switch or an IG switch of a gas vehicle is ON. Thus, the present application can be applied to a hybrid vehicle or an electric vehicle.

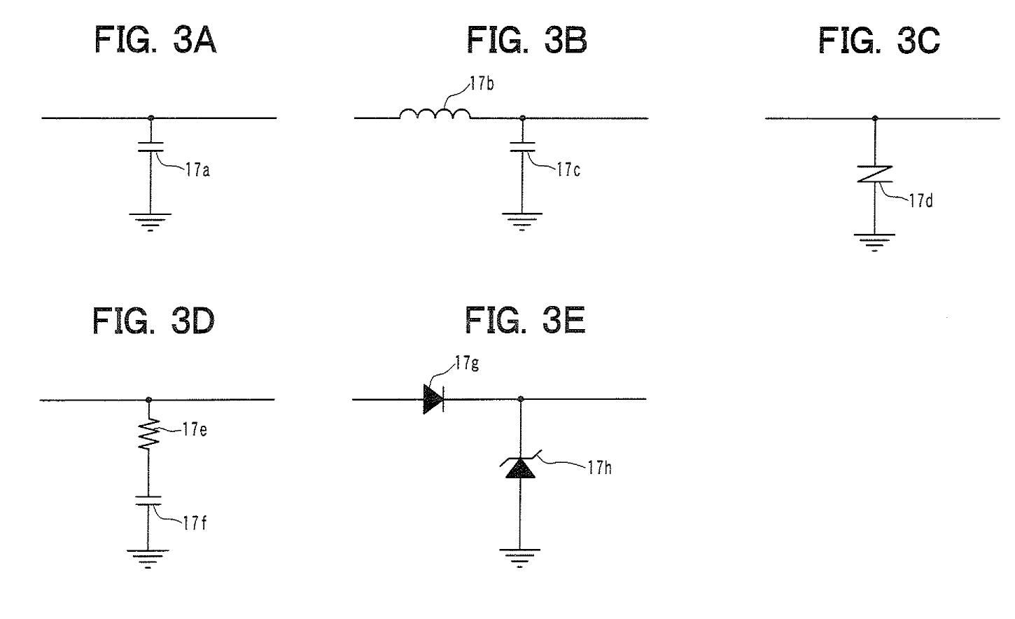

FIGS. 3A-3E illustrate modifications of the noise protection circuit. As shown in FIG. 3A, the noise protection circuit can include a capacitor 17a connected in parallel with the power line. As shown in FIG. 3B, the noise protection circuit can include a coil 17b connected in serial with the power line and a capacitor 17c connected in parallel with the power line on the downstream side of the coil 17b. As shown in FIG. 3C, the noise protection circuit can include a varistor 17d connected in parallel with the power line. As shown in FIG. 3D, the noise protection circuit can include a series circuit of a resistor 17e and a capacitor 17f connected in parallel with the power line. As shown in FIG. 3E, the noise protection circuit can include a diode 17g connected in serial with the power line and a Zener diode 17h connected in parallel with the power line on the downstream side of the diode 17g.

The noise protection circuit shown in FIGS. 3A-3D can serve by itself as a surge protection circuit. The noise protection circuit shown in FIGS. 3A-3D can be combined with a relay to serve as protection against both surge and reverse connection. The noise protection circuit shown in FIG. 3E can serve by itself as protection against both surge and reverse connection.

Such changes and modifications are to be understood as being within the scope of the present invention as defined by the appended claims.

What is claimed is:

1. A vehicular power supply circuit for supplying power to a plurality of loads from a battery to drive the plurality of loads, the vehicular power supply circuit comprising:
a power line connected to the plurality of loads, the power line systematically separated into a plurality of power lines based on characteristics of the plurality of loads connected thereto, and
a plurality of noise protection circuits, each noise protection circuit provided to a corresponding power line on the upstream side of the plurality of loads connected to the corresponding power line.

2. The vehicular power supply circuit according to claim 1, wherein
the plurality of power lines has a first line and a second line,
the plurality of loads includes a first load connected to the first line and a second load connected to the second line, and
the first load requires protection against a short-circuit current that is caused under an reverse connection condition where negative and positive terminals of the battery are reversely connected, and
the second load does not require the protection against the short-circuit current caused under the reverse connection condition.

3. The vehicular power supply circuit according to claim 1, wherein
the plurality of power lines includes a first power line and a second power line,
the first power line is connected directly to the battery and supplied with the power regardless of whether an ignition switch, an accessory switch, or a start switch of a vehicle is in an ON position,
the second power line is supplied with the power only when the ignition switch, the accessory switch, or the start switch of the vehicle is in the ON position,
the first power line has a first line and a second line,
the plurality of loads connected to the first power line includes a first load connected to the first line and a second load connected to the second line,
the first load requires protection against a short-circuit current caused under an reverse connection condition where negative and positive terminals of the battery are reversely connected, and
the second load does not require the protection against the short-circuit current caused under the reverse connection condition.

4. The vehicular power supply circuit according to claim 3, wherein
the noise protection circuit provided to the first power line includes a relay and a surge protection device,
the relay is provided to the first line of the first power line to allow the power to be supplied to the first load or to prevent the power from being supplied to the first load, and
the surge protection device is provided to the first line on the downstream side of the relay.

5. The vehicular power supply circuit according to claim 3, further comprising:
a relay, wherein
the first power line includes a small current line through which a small current flows and a large current line through which a large current larger than the small current flows,
the relay is provided to the small current line to allow the power to be supplied to the plurality of loads connected to the small current line or prevent the power from being supplied to the plurality of loads connected to the small current line, and
the noise protection circuit provided to the first power line is located on the upstream side of the relay.

6. The vehicular power supply circuit according to claim 3, wherein
the noise protection circuit provided to the second power line includes a relay and a surge protection device,
the relay is provided to the second power line to allow the power to be supplied to the plurality of loads connected to the second power line when the ignition switch, the accessory switch, or the start switch of the vehicle is in the ON position, and
the surge protection device is provided to the second power line on the downstream side of the relay.
